(19) United States
(12) Patent Application Publication
(10) Pub. No.: US 2024/0344957 A1
(43) Pub. Date: Oct. 17, 2024

(54) AEROSOL GENERATING SYSTEM

(71) Applicant: JIANGSU SUJING GROUP CO., LTD., Suzhou, Jiangsu (CN)

(72) Inventors: Fengfei LIANG, Suzhou, Jiangsu (CN); Weidong SHEN, Suzhou, Jiangsu (CN); Jiyong SUN, Suzhou, Jiangsu (CN); Jun XIE, Suzhou, Jiangsu (CN); Chenwei WU, Suzhou, Jiangsu (CN)

(21) Appl. No.: 18/574,870

(22) PCT Filed: Feb. 24, 2022
(86) PCT No.: PCT/CN2022/077672

§ 371 Date: Dec. 28, 2023

(30) Foreign Application Priority Data
Dec. 27, 2021 (CN) 202111610123.3

(51) Int. Cl. G01N 15/08; B03C 7/02

(52) U.S. Cl. CPC G01N 15/0806; B03C 7/02; G01N 2015/084

(57) ABSTRACT

An aerosol generation system is provided, including an aerosol generator, a primary separation assembly, and a secondary separation assembly, the primary separation assembly includes a primary separation chamber and a pair of electrode plates, an inlet of the primary separation chamber is connected to an outlet of the aerosol generator, and a channel is formed between the pair of the electrode plates for aerosol particles to pass through; the secondary separation assembly comprises a secondary separation chamber, and an inlet of the secondary separation chamber is connected to an outlet of the primary separation chamber. The present disclosure achieves the requirements of different standard particle sizes for filter material testing equipment, the output of aerosols with different particle sizes and concentrations can be achieved by adjusting the voltage and length of the electrode plates, or the size and distance of the mechanical separation plate.

### CROSS-REFERENCE TO RELATED APPLICATIONS

This application claims priority to PCT/CN2022/077672, filed on Feb. 24, 2022, which claims priority to Chinese Application No. 202111610123.3, filed on Dec. 27, 2021, the entire contents both of which are hereby incorporated by reference.

### FIELD OF TECHNOLOGY

The following relates to the field of filter materials and testing technology, and in particular, relates to an aerosol generation system.

### BACKGROUND

As the progress of society and the improvement of people's living standards, the requirements for various daily necessities in China are gradually increasing, and the filtration efficiency testing of particle filter materials has also entered the attention range of people, especially after the outbreak of the epidemic, people's concern for masks and other related filter materials has greatly increased, and higher requirements have been put forward for the filtration efficiency testing standards of filter materials in China. However, the differences in Chinese standards, European Union standards, and American standards place higher requirements on testing instruments, especially strict requirements for aerosol particle size.

At present, the commonly used aerosol generator nozzles mainly have structures such as Laskin and Colin, but the aerosol particle size range generated by nozzles with different structures is different, which cannot meet the standard requirements of aerosols in various countries and regions at the same time. Therefore, developing an aerosol generation device with adjustable particle size range has become one of the important goals in the field of aerosol testing and cleaning.

### SUMMARY

An aspect relates to an aerosol generation system, in particular a polydisperse aerosol generation system with relatively concentrated particle sizes, which separates aerosol particles by particle size and achieves the centralization of particle size distribution, and is suitable for use in filter material testing equipment.

To achieve the above purposes, a technical solution employed by the present disclosure is:

An aerosol generation system, comprises:
an aerosol generator to generate aerosol particles,
a primary separation assembly for separating aerosol particles with a particle size of r1, the primary separation assembly comprising a primary separation chamber, a pair of electrode plates arranged within the primary separation chamber and located between its inlet and outlet, and a power supply connected to the pair of electrode plates to apply a voltage to them, the inlet of the primary separation chamber being connected to an outlet of the aerosol generator, and a channel being formed between the pair of the electrode plates for aerosol particles to pass through;
a secondary separation assembly for separating aerosol particles with a particle size of r2, the secondary separation assembly comprising a secondary separation chamber, an inlet of the secondary separation chamber being connected to the outlet of the primary separation chamber, and r1 is less than r2.

That is to say, by adjusting the voltage applied to the pair of electrode plates in the primary separation assembly, the separation of aerosol particles with smaller particle sizes can be achieved, and then the separation of aerosol particles with larger particle sizes can be achieved by the secondary separation assembly, so as to achieve the separation of aerosol particles with different particle size ranges.

In an embodiment, to the above technical solution, the pair of electrode plates is arranged horizontally up and down, a channel extending in a horizontal direction is formed between the pair of electrode plates, and holes are provided on the lower electrode plate, and are used for the passage of aerosol particles separated in the primary separation.

In an embodiment, the system further comprises a diversion pipe, an inlet of the diversion pipe is connected to the primary separation chamber and located below the lower electrode plate, and an outlet of the diversion pipe is connected to the aerosol generator. The liquid flow collected by separation flows back to the aerosol generator through the diversion pipe.

In an embodiment, to the above technical solution, the electric field intensity between the pair of electrode plates is above 100 V/cm, or a voltage applied to the pair of electrode plates by the power supply is in the range of 50-200 V.

In an embodiment, to the above technical solution, the secondary separation assembly further comprises an impact block, the impact block is at least partly located within the secondary separation chamber, the impact block is arranged directly opposite the inlet of the secondary separation chamber, and the impact block can move in the direction close to and away from the inlet of the secondary separation chamber. The secondary separation assembly can select an impact distance specifically by adjusting the distance between the impact block and the inlet of the secondary separation chamber, thereby achieving the separation of aerosol particles with larger particle sizes.

In an embodiment, to the above technical solution, the inlet of the secondary separation chamber is horizontally oriented.

In an embodiment, to the above technical solution, the system further comprises a storage tank, and the storage tank is used to collect aerosol particles that have undergone secondary separation, and is connected to the secondary separation chamber. The liquid generated by the separation of the secondary separation assembly is stored in the storage tank for reuse.

In an embodiment, to the above technical solution, the aerosol generator comprises a liquid storage tank and an aerosol nozzle arranged within the liquid storage tank, the aerosol nozzle is connected to an air intake pipe and a liquid suction pipe, and one end of the air intake pipe extends out of the liquid storage tank to form an air inlet end: the liquid suction pipe is located in the liquid storage tank and extends to the bottom of the liquid storage tank: the outlet of the aerosol nozzle is connected to the inlet of the primary separation chamber.

In an embodiment, the aerosol generator further comprises a compressed air source, which is connected to the air inlet end of the air intake pipe.

In an embodiment, the pressure of the compressed air source is 0.1 MPa-0.5 MPa.

The design principle of the present disclosure is:

The aerosol generator utilizes high-pressure clean compressed air to produce aerosol particles with different particle sizes,

For the primary separation assembly: aerosol particles with different particle sizes enter the primary separation chamber, assuming that the particle size of the aerosol is r, the density of the aerosol is p, and the electric field intensity between the pair of electrode plates is E, the lateral velocity of each aerosol particle flying in the primary separation chamber is the wind speed v at this time, assuming the length of the primary separation chamber is L, the maximum flight time of each aerosol particle in the primary separation chamber is:

$$\\ \begin{matrix}T = \frac{L}{υ} & ( 1 )\end{matrix}$$

Then its maximum radial displacement is:

$$\\ \begin{matrix}Δ L = \frac{3}{8} \times \frac{Ee}{ρ π {r}^{{}_{} 3}} \times {( \frac{L}{υ} )}^{2} & ( 2 )\end{matrix}$$

Through equation (2), it can be seen that the radial flight displacement of aerosol particles is inversely proportional to the cube of their particle size r, and when limiting the length L of the primary separation chamber and the wind speed of aerosol particles, the smaller the particle size of the aerosol particles, the larger the radial displacement thereof, and the easier they are to be collected by the pair of electrode plates. Therefore, the separation of aerosol particles with smaller particle sizes can be achieved by adjusting the electric field intensity between the pair of electrode plates.

For the secondary separation assembly: aerosol particles enter the secondary separation chamber, aerosol particles with larger particle sizes hit the impact block due to their inertia forces coming out of the primary separation assembly, and according to the momentum theorem, the larger the particle size, the greater the inertia force of the aerosol particles, and the easier they are to hit the impact block, thus achieving the separation of aerosol particles with larger particle sizes.

Due to the use of the above technical solutions, the present disclosure has the following advantages over the conventional art:

The present disclosure adopts two-stage separation for particle size separation of aerosol particles, achieving the requirements of different standard particle sizes for filter material testing equipment, at the same time, the output of aerosols with different particle sizes and concentrations can be achieved by adjusting the voltage and length of the electrode plates, or the size and distance of the mechanical separation plate, and it has the advantages of simple structure, convenient adjustment, and meeting various needs, truly realizing one machine with multiple functions.

### BRIEF DESCRIPTION

Some of the embodiments will be described in detail, with references to the following Figures, wherein like designations denote like members, wherein:

FIG. 1 is a three-dimensional schematic diagram of this embodiment;

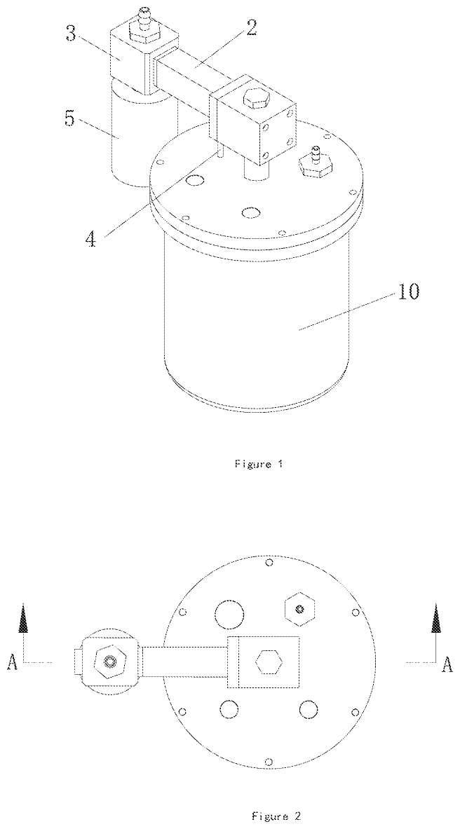

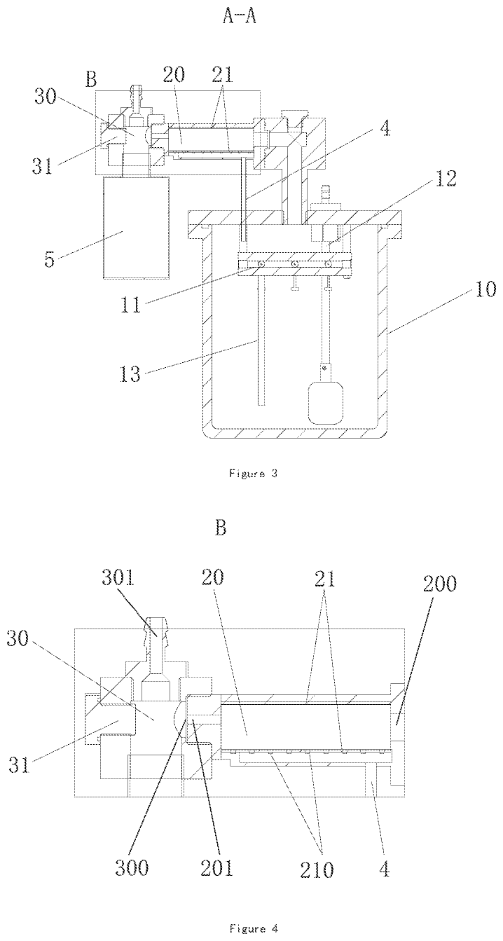

FIG. 2 is a top view of this embodiment;

FIG. 3 is a cross-sectional schematic diagram along Line A-A in FIG. 2; and

FIG. 4 is an enlarged schematic diagram of Part B in FIG. 3.

In the figures:

10, liquid storage tank; 11, aerosol nozzle; 12, air intake pipe; 13, liquid suction pipe; 2, primary separation assembly; 20, primary separation chamber; 200, inlet; 201, outlet; 21, electrode plate; 210, hole; 3, secondary separation assembly; 30, secondary separation chamber; 300, inlet; 301, outlet; 31, impact block; 4, diversion pipe; 5, storage tank.

### DETAILED DESCRIPTION

The technical solutions of the present disclosure will be described clearly and completely below with reference to the accompanying drawings. Apparently, the described embodiments are merely some of rather than all of the embodiments of the present disclosure. All other embodiments obtained by those of ordinary skill in the conventional art without creative efforts based on the embodiments of the present disclosure shall fall within the protective scope of the present disclosure.

In the description of the present disclosure, it should be noted that the orientations or positional relationships indicated by the terms “center”, “upper”, “lower”, “left”, “right”, “vertical”, “horizontal”, “inner”, “outer”, etc. are based on those shown in the accompanying drawings, are only for the convenience of describing the present disclosure and simplifying the description, rather than indicating or implying that the indicated device(s) or element(s) must have a specific orientation, be constructed and operated in a specific orientation, and therefore should not be construed as a limitation of the present disclosure. Furthermore, the terms “first”, “second” and “third” are used for descriptive purposes only and should not be construed to indicate or imply relative importance.

In the description of the present disclosure, it should be noted that, unless otherwise expressly specified and limited, the terms “mount”, “communicate”, and “connect” should be understood in a broad sense, for example, it may be fixedly connected or detachably connected, or integrated: it may be mechanically connected or electrically connected: it can be directly connected or indirectly connected through an intermediate medium, or it can be the internal communication of two elements. For those of ordinary skill in the conventional art, the specific meanings of the above terms in the present disclosure can be understood according to specific situations.

An aerosol generation system as shown in FIGS. 1-4, comprises an aerosol generator, a primary separation assembly 2 and a secondary separation assembly 3, wherein:

The aerosol generator is to generate aerosol particles. In this embodiment, the aerosol generator comprises:
a liquid storage tank 10, to store a solution required for the generation of aerosol particles;
an aerosol nozzle 11, to generate required aerosol particles, the aerosol nozzle 11 being arranged in the liquid storage tank 10, the outlet of the aerosol nozzle 11 being connected to an inlet 200 of the primary separation assembly 2;
a compressed air source, to provide high-pressure gas such as clean compressed air required for aerosol generation. The pressure of the compressed air source is 0.1 MPa-0.5 MPa.

The aerosol nozzle 11 is connected to an air intake pipe 12 and a liquid suction pipe 13, one end of the air intake pipe 12 extends out of the liquid storage tank 10 and forms an air inlet end, and the compressed air source is connected to the air inlet end of the air intake pipe 12: the liquid suction pipe 13 is located in the liquid storage tank 10 and a mouth portion of one end thereof extends to the bottom of the liquid storage tank 10 so as to suck the solution from the bottom of the liquid storage tank 10. The aerosol nozzle 11 has not been improved, and the existing aerosol nozzle can be used, and its specific principle will not be described here.

The clean compressed air with a pressure of 0.1 MPa-0.5 MPa provided by the compressed air source enters the aerosol nozzle 11 through the air intake pipe 12 and is sprayed out to create negative pressure inside the aerosol nozzle 11, the liquid suction pipe 13 sucks the solution in the liquid storage tank 10 into the aerosol nozzle 11 and atomizes it to produce aerosol particles, and the generated aerosol particles enter the primary separation assembly 2 through the outlet of the aerosol nozzle 11.

The primary separation assembly 2 is to separate aerosol particles with smaller particle sizes. The primary separation assembly 2 comprising a primary separation chamber 20, a pair of electrode plates 21 arranged within the primary separation chamber 20 and located between its inlet 200 and outlet 201, and a power supply connected to the pair of electrode plates 21 to apply a voltage to them, the inlet 200 of the primary separation chamber 20 is connected to an outlet of the aerosol nozzle 11 of the aerosol generator, and a channel is formed between the pair of the electrode plates 21 for aerosol particles to pass through.

Specifically, the pair of electrode plates 21 is arranged horizontally up and down, a channel extending in a horizontal direction is formed between the pair of the electrode plates 21, in the figures, the inlet 200 of the primary separation chamber 20 is directly opposite the inlet of the channel between the pair of electrode plates 21, ensuring that aerosol particles entering the primary separation chamber 20 enter the channel between the pair of electrode plates 21, and the inlet 200 being coaxial with the channel is desired. The lower electrode plate 21 is provided with holes 210, for example, the lower electrode plate 21 is a hollow plate, and the holes 210 are used for the passage of aerosol particles separated in the primary separation.

In addition, the system further comprises a diversion pipe 4, an inlet of the diversion pipe 4 is connected to the primary separation chamber 20 and located below the lower electrode plate 21, and an outlet of the diversion pipe 4 is connected to the liquid storage tank 10 of the aerosol generator, such that the liquid flow collected by separation flows back to the liquid storage tank 10 of the aerosol generator through the diversion pipe 4 for storage and reuse.

After the aerosol particles enter the primary separation chamber, under the action of a high-voltage electric field between the pair of electrode plates 21, aerosol particles attach electric charges and a radial force is formed on the charged particles, and aerosol particles with smaller particle sizes will hit different positions on the pair of electrode plates 21 under the action of the electric field. During the primary separation process, the separation of smaller aerosol particles can be achieved by adjusting the voltage between the pair of electrode plates 21, the adjustment range of the voltage is 50-200 V. or the adjustment range of the electric field intensity is above 100 V/cm, and the specific voltage or electric field intensity can be set according to the particle sizes to be separated.

The secondary separation assembly 3 is to separate aerosol particles with larger particle sizes, and the particle size of the aerosol particles separated by secondary separation assembly 3 is greater than that of the aerosol particles separated by primary separation assembly 2. The secondary separation assembly 3 comprises a secondary separation chamber 30 and an impact block 31, the inlet 300 of the secondary separation chamber 30 is connected to the outlet 201 of the primary separation chamber 20, the inlet 300 of the secondary separation chamber 30 is horizontally oriented, and the outlet 301 of the secondary separation chamber 30 is located above it. In FIG. 4, the axes of the inlet 200 of the primary separation chamber 30, the channel between the pair of electrode plates 21 and the inlet 300 of the secondary separation chamber 30 coincide.

The impact block 31 is at least partly located within the secondary separation chamber 30, the impact block 31 is arranged directly opposite the inlet 300 of the secondary separation chamber 30, and the impact block 31 can move in the direction close to and away from the inlet 300 of the secondary separation chamber 30. The secondary separation assembly 3 can select an impact distance specifically by adjusting the distance between the impact block 31 and the inlet 300 of the secondary separation chamber 30, thereby achieving the separation of aerosol particles with larger particle sizes. For example, the impact block 31 can be connected to the cavity wall of the secondary separation chamber 30 through threaded means, and by rotating the impact block 31, the distance between it and the inlet 300 of the secondary separation chamber 30 can be adjusted, or methods such as fitting with bolts can be adopted.

Furthermore, the system further comprises a storage tank 5, and the storage tank 5 is used to collect aerosol particles that have undergone secondary separation, and the storage tank 5 is connected to the secondary separation chamber 30 and below the secondary separation chamber 30. The liquid generated by the separation of the secondary separation assembly 3 is stored in the storage tank 5 for reuse later. Of course, it can also be directly returned to the liquid storage tank 10 in the aerosol generator for storage and reuse, such as through a diversion pipe.

The operating principle of this embodiment is explained in detail as follows:

The clean compressed air generated by the compressed air source enters the aerosol nozzle 11 in the liquid storage tank 10 through the air intake pipe 12, airflow is sprayed out from the aerosol nozzle 11 to create negative pressure inside the aerosol nozzle 11, the negative pressure sucks the aerosol liquid through the liquid suction pipe 13 into the aerosol nozzle 11 to produce aerosol particles, and the aerosol particles enter the primary separation assembly 20 through the outlet of the aerosol nozzle 11.

The aerosol particles entering the primary separation chamber 20 pass through the pair of electrode plates 21, and through the set voltage or electric field intensity, the aerosol particles with different particle sizes are driven to fly laterally under the transverse pressure, and at the same time, they have a radial velocity under the effect of the radial electric field force, and due to that the acceleration of aerosol particles with different particle sizes is different, their radial displacement will also be different, and the smaller the particle size, the greater the radial displacement, and the easier it is to hit the pair of electrode plates 21, the aerosol particles with smaller particle sizes that hit the upper electrode plate 21 converge into liquid and drip onto the lower electrode plate 21 under the action of gravity, and together with the aerosol particles with smaller particle sizes that hit and converge on the lower electrode plate 21, they flow back to the liquid storage tank 10 through the diversion pipe 4 through the holes 210 on the lower electrode plate 21.

The aerosol particles after primary separation enter the secondary separation chamber 30 through the outlet 201 of the primary separation chamber 20, the jet airflow through the inlet 300 of the secondary separation chamber 30 inertially impacts the particles with larger particle sizes onto the impact block 31, the aerosol particles with larger particle sizes fall under gravity into the storage tank 5 below the secondary separation chamber 30 for storage, the remaining aerosol particles that meet the particle size requirements after separation are discharged from the outlet 301 of the secondary separation chamber 30 under the action of airflow for the required testing. In this way, the separation of aerosol with different particle sizes can be achieved by adjusting the distance between the impact block 31 and the inlet 300 of the secondary separation chamber 30.

The separation of aerosol particles with smaller particle sizes can be achieved by adjusting the primary separation assembly 2, then the separation of aerosol particles with larger particle sizes can be achieved by the secondary separation assembly 3, in this way the separation of aerosol particles with different particle size ranges can be achieved, so that the particle size range of the separated aerosol particles can meet multiple national standards such as EU standards, US standards, and Chinese standards.

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. An aerosol generation system comprising an aerosol generator for generating aerosol particles comprising:
a primary separation assembly for separating aerosol particles with a particle size of r1, the primary separation assembly comprising a primary separation chamber, a pair of electrode plates arranged within the primary separation chamber and located between an inlet and an outlet, and a power supply connected to the pair of electrode plates to apply a voltage to the pair of electrode plates, the inlet of the primary separation chamber being connected to an outlet of the aerosol generator, and a channel being formed between the pair of the electrode plates for aerosol particles to pass through; and
a secondary separation assembly for separating aerosol particles with a particle size of r2, the secondary separation assembly comprising a secondary separation chamber, an inlet of the secondary separation chamber being connected to the outlet of the primary separation chamber, and r1 is less than r2.

2. The aerosol generation system according to claim 1, wherein the pair of electrode plates is arranged horizontally up and down, and a channel extending in a horizontal direction is formed between the pair of electrode plates.

3. The aerosol generation system according to claim 2, wherein a lower electrode plate is provided with holes, and the holes are used for the passage of aerosol particles separated in the primary separation chamber.

4. The aerosol generation system according to claim 2, further comprising a diversion pipe, and an inlet of the diversion pipe is connected to the primary separation chamber and located below the lower electrode plate.

5. The aerosol generation system according to claim 4, wherein an outlet of the diversion pipe is connected to the aerosol generator.

6. The aerosol generation system according to claim 1, wherein the secondary separation assembly further comprises an impact block, the impact block is at least partly located within the secondary separation chamber, and the impact block is arranged directly opposite the inlet of the secondary separation chamber.

7. The aerosol generation system according to claim 6, wherein the impact block is movable in a direction close to and away from the inlet of the secondary separation chamber.

8. The aerosol generation system according to claim 1, wherein the inlet of the secondary separation chamber is horizontally oriented.

9. The aerosol generation system according to claim 1, further comprising a storage tank, and the storage tank is used to collect aerosol particles that have undergone secondary separation, and is connected to the secondary separation chamber.

10. The aerosol generation system according to claim 1, wherein the aerosol generator comprises a liquid storage tank and an aerosol nozzle arranged within the liquid storage tank, the aerosol nozzle is connected to an air intake pipe and a liquid suction pipe, and one end of the air intake pipe extends out of the liquid storage tank to form an air inlet end; the liquid suction pipe is located in the liquid storage tank and extends to a bottom of the liquid storage tank: the outlet of the aerosol nozzle is connected to the inlet of the primary separation chamber.

11. The aerosol generation system according to claim 10, wherein the aerosol generator further comprises a compressed air source, which is connected to the air inlet end of the air intake pipe.

12. An aerosol generation system, comprising:
an aerosol generator, for generating aerosol particles, and comprising a liquid storage tank, an aerosol nozzle arranged within the liquid storage tank and a compressed air source, the aerosol nozzle being connected to an air intake pipe and a liquid suction pipe, and one end of the air intake pipe extending out of the liquid storage tank to form an air inlet end; the liquid suction pipe being located in the liquid storage tank and extending to a bottom of the liquid storage tank, and the compressed air source being connected to the air inlet end of the air intake pipe;
a primary separation assembly, for separating aerosol particles with a particle size of r1 and comprising a primary separation chamber, a pair of electrode plates arranged within the primary separation chamber and located between an inlet and an outlet, and a power supply connected to the pair of electrode plates to apply a voltage to the pair of electrode plates, the inlet of the primary separation chamber being connected to an outlet of the aerosol generator, the pair of electrode plates being arranged horizontally up and down, and a channel extending in a horizontal direction being formed between the pair of the electrode plates for aerosol particles to pass through, a lower electrode plate being provided with holes, and the holes being used for the passage of aerosol particles that have undergone the primary separation;
a secondary separation assembly, for separating aerosol particles with a particle size of r2, r1 being less than r2, the secondary separation assembly further comprising a secondary separation chamber and an impact block, an inlet of the secondary separation chamber being connected to the outlet of the primary separation chamber, and the inlet of the secondary separation assembly being horizontally oriented: the impact block being at least partly located within the secondary separation chamber, the impact block being arranged directly opposite the inlet of the secondary separation chamber, and the impact block is movable in a direction close to and away from the inlet of the secondary separation chamber;
a diversion pipe, an inlet of the diversion pipe being connected to the primary separation chamber and located below the lower electrode plate, and an outlet of the diversion pipe being connected to the aerosol generator; and
a storage tank, the storage tank being used to collect aerosol particles that have undergone the secondary separation, and being connected to the secondary separation chamber.

13. The aerosol generation system according to claim 1, wherein an electric field intensity between the pair of electrode plates is above 100 V/cm.

14. The aerosol generation system according to claim 1, wherein a voltage applied to the pair of electrode plates by the power supply is in the range of 50-200 V.

15. The aerosol generation system according to claim 11, wherein a pressure of the compressed air source is 0.1 MPa-0.5 MPa.
